(19) United States
(12) Patent Application Publication
(10) Pub. No.: US 2026/0233408 A1
(43) Pub. Date: Aug. 13, 2026

(54) ROBOT CONTROL SYSTEM

(71) Applicant: HONDA MOTOR CO., LTD., Minato-ku, Tokyo (JP)

(72) Inventor: Taizo Yoshikawa, Wako-shi (JP)

(21) Appl. No.: 19/469,584

(22) PCT Filed: Mar. 15, 2024
(86) PCT No.: PCT/JP2024/010277

§ 371 Date: Sep. 26, 2025

(30) Foreign Application Priority Data
Mar. 30, 2023 (JP) 2023-055665

(51) Int. Cl. B25J 9/16; B25J 9/00; B25J 13/08

(52) U.S. Cl. CPC B25J 9/1697; B25J 9/0087; B25J 13/089

(57) ABSTRACT

A robot control system is a robot control system that controls a robot in a space where the robot is not in contact with a ground, and includes: a robot body; an arm connected to the robot body; a position acquisitor that acquires an arm origin set in a vicinity of a point at which the arm is connected to the robot body and a position of an arm distal end portion which is a distal end of the arm; and a position command calculator that defines a constraint model set between the arm origin and the arm distal end portion, calculates a constraining force generated according to a change in a distance between the arm origin and the arm distal end portion from the constraint model, and calculates a position command of the robot body from a value of the constraining force.

### TECHNICAL FIELD

The present invention relates to a robot control system.

Priority is claimed on Japanese Patent Application No. 2023-055665, filed Mar. 30, 2023, the content of which is incorporated herein by reference.

### BACKGROUND ART

There is a device that performs work while moving under water. Such a device includes a thruster, an image-capturing camera, and the like (see, for example, Patent Document 1). In such a device, for example, a manipulator is optional, and it is necessary to separately operate a device body and the manipulator.

### CITATION LIST

### Patent Document

Patent Document 1: Japanese Patent (Granted) Publication No. 5806568

### SUMMARY OF INVENTION

### Technical Problem

However, in the conventional underwater device system, it is not possible to simultaneously operate the device body and the manipulator. Therefore, for example, it is difficult to operate the manipulator in a situation where a position of the device body is not stable due to disturbance such as water flow.

An aspect according to the present invention has been made in view of the above problems, and an object thereof is to provide a robot control system capable of improving a working capacity using a manipulator in a space where a robot is not in contact with a ground.

### Solution to Problem

In order to solve the above-described problem to be solved by the invention, the present invention adopts the following aspects.

(1) A robot control system according to one aspect of the present invention is a robot control system that controls a robot in a space where the robot is not in contact with a ground, and includes: a robot body; an arm connected to the robot body; a position acquisitor that acquires an arm origin set in a vicinity of a point at which the arm is connected to the robot body and a position of an arm distal end portion which is a distal end of the arm; and a position command calculator that defines a constraint model set between the arm origin and the arm distal end portion, calculates a constraining force generated according to a change in a distance between the arm origin and the arm distal end portion from the constraint model, and calculates a position command of the robot body from a value of the constraining force.

(2) In the above aspect (1), a dead zone may be set in the constraint model.

(3) In the above aspect (1) or (2), the constraint model may be a muscle model or a model based on a potential method.

(4) In any one of the above aspects (1) to (3), the constraint model may be one of a constraint that determines a front-rear movement command of the robot body, a constraint that determines a left-right movement command of the robot body, a constraint that determines an upward-downward movement command of the robot body, and a constraint that determines a rotation command for rotation of the robot body.

(5) In any one of the above aspects (1) to (3), a camera may be further included, the constraint model may be a constraint that determines a rotation command for rotation of the robot body, and a center of the rotation may be one of a center of the robot body, a pan axis of the camera, a hand position, and a virtual position.

(6) In the above aspect (5), the center of the rotation may be a position at which a change in a field of view of the camera is small when the robot body moves, the position being one of the center of the robot body, the pan axis of the camera, the hand position, and the virtual position.

(7) In the above aspect (5), the position command calculator may select one center of the rotation among the center of the robot body, the pan axis of the camera, the hand position, and the virtual position according to a working state.

(8) In any one of the above aspects (1) to (7), the position command calculator may estimate a hand position viewed from the arm origin by calculation of forward kinematics from joint angle information of the arm, and calculate a constraining force between the arm origin and the arm distal end portion from the constraint model.

(9) In any one of the above aspects (1) to (7), in a case where there are a plurality of the arms, the position command calculator may calculate the constraining force for each of the arms, add the calculated constraining forces of the plurality of arms, and use a change in compliance control as a command.

(10) In the above aspect (2), in a case where there are a plurality of the arms, the dead zone may be located between a vicinity of a point at which a first arm is connected to the robot body and a vicinity of a point at which a second arm is connected to the robot body.

### Advantageous Effects of Invention

According to the aspect of the present invention, it is possible to improve the working capacity using the manipulator in the space where the robot is not in contact with the ground.

### BRIEF DESCRIPTION OF DRAWINGS

FIG. 1 A view illustrating an appearance example and a schematic configuration example of a robot control system according to an embodiment as viewed from above.

FIG. 2 A view illustrating an appearance example of the robot control system according to the embodiment as viewed from the side.

FIG. 3 A diagram illustrating a configuration example of the robot control system according to the embodiment.

FIG. 4 A view illustrating a coordinate system and an origin in the robot control system.

FIG. 5 A view illustrating a coordinate system and an origin in the robot control system.

FIG. 6 A view for describing examples of constraint conditions used in the embodiment.

FIG. 7 A view illustrating an example of a muscle model.

FIG. 8 A view for describing a constraint that determines a forward-backward movement (x-axis direction) command of a robot body.

FIG. 9 A flowchart of how to obtain a constraining force in the constraint that determines the forward-backward movement command of the robot body.

FIG. 10 A view for describing a constraint that determines a left-right movement (y-axis direction) command of the robot body.

FIG. 11 A flowchart of how to obtain a constraining force in the constraint that determines the left-right movement command of the robot body.

FIG. 12 A view for describing a constraint that determines an upward-downward movement (z-axis direction) command of the robot body.

FIG. 13 A flowchart of how to obtain a constraining force in the constraint that determines the upward-downward movement command of the robot body.

FIG. 14 A view for describing a constraint that determines a rotational movement (z-axis rotation) command of the robot body.

FIG. 15 A flowchart of command processing for the robot body.

FIG. 16 A view for describing a change in each axis and a definition of an offset.

FIG. 17 A view illustrating an example in a case where a rotation center is an origin of the robot body.

FIG. 18 A view illustrating an example in a case where the rotation center is a pan axis of a camera.

FIG. 19 A view illustrating an example in a case where the rotation center is a virtual work position.

FIG. 20 A view illustrating an example in a case where the rotation center is a hand position of a left arm.

FIG. 21 A view illustrating an example in which an image-capturing range is shifted when rotation is performed about the origin of the robot body as the rotation center.

FIG. 22 A view illustrating an example of the image-capturing range in a case where rotation is performed about the pan axis of the camera as the rotation center.

FIG. 23 A view illustrating an example in which the image-capturing range is shifted also in a case where the virtual work position is set and rotation is performed about the origin of the robot body.

FIG. 24 A view illustrating an example of a field of view in a case where rotation is performed about the virtual work position.

FIG. 25 A view illustrating an absolute coordinate system, a virtual absolute coordinate system, and a robot coordinate system, and positions and posture positions of the robot body and a hand.

FIG. 26 A diagram illustrating an example of a command generation block for the robot according to the embodiment.

### DESCRIPTION OF EMBODIMENTS

Hereinafter, an embodiment of the present invention will be described with reference to the drawings. Note that, in the drawings used in the following description, the scale of each member is appropriately changed in order to make each member recognizable in size.

Note that, in all the drawings for describing the embodiment, components having the same function are denoted by the same references, and repeated description is omitted.

In addition, as used herein, “on the basis of XX” means “based on at least XX”, and includes “based on another element in addition to XX”. In addition, “on the basis of XX” is not limited to a case where XX is directly used, and includes a case where calculation or processing is performed on XX. “XX” is an any element (for example, any information).

### (Appearance Example of Robot Control System)

First, an appearance example and a schematic configuration example of a robot control system 1 will be described. Note that, in each of the following examples, an underwater robot or an underwater drone that performs work under water will be described as an example of a robot, but a work space of the robot is not limited thereto. The work space of the robot may be a space in which a robot body 101 is not in contact with the ground or the like, for example, in the air or outer space. In addition, the robot body is also referred to as the “robot” in the embodiment.

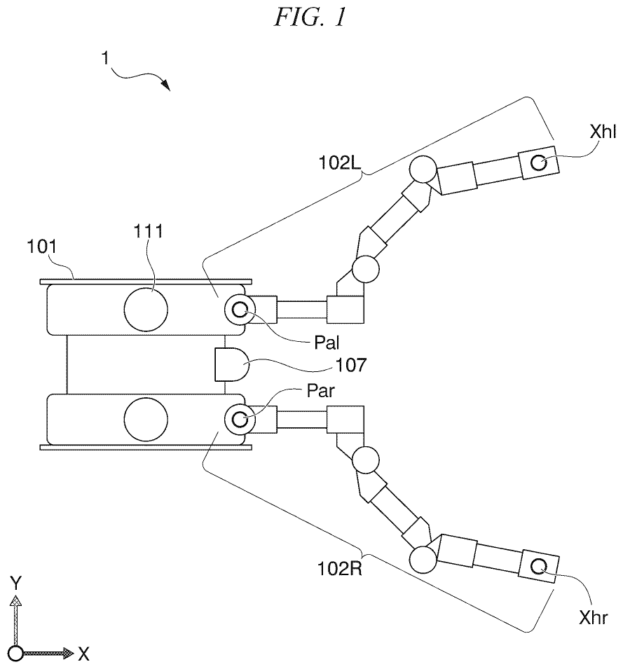

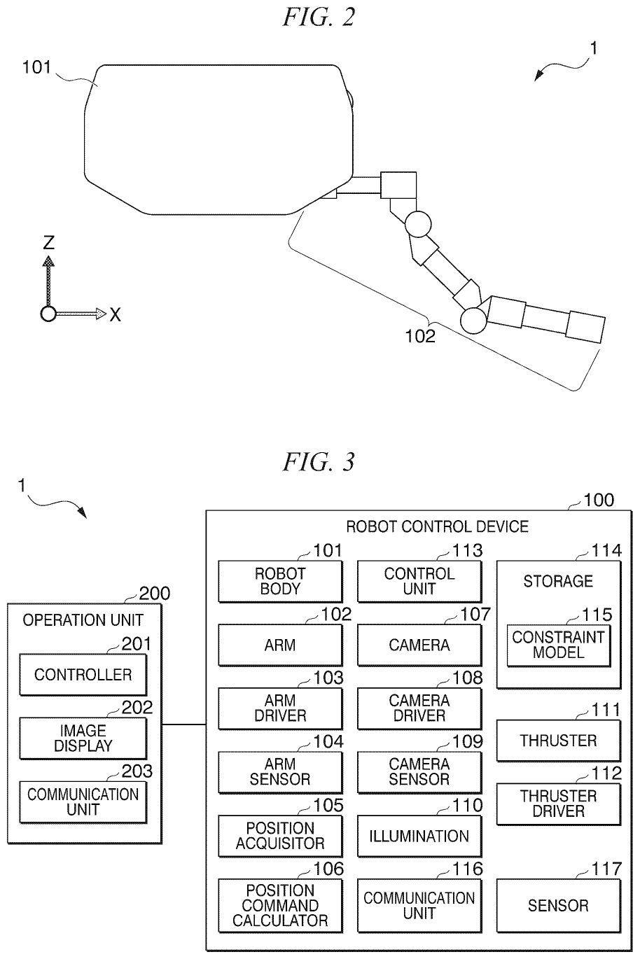

FIG. 1 is a view illustrating an appearance example and a schematic configuration example of the robot control system according to the present embodiment as viewed from above. FIG. 2 is a view illustrating an appearance example of the robot control system according to the present embodiment as viewed from the side.

The robot control system 1 includes, for example, the robot body 101, an arm 102 (102L, 102R) connected to the robot body 101, a camera 107, and a thruster 111. Note that it is sufficient to include one or more arms 102.

An arm origin Pa (Pal, Par) is set in the vicinity of a point at which the arm 102 is connected to the robot body 101. The arm origin may be any spot on a shoulder side of the arm 102. A reference Xh (Xhl, Xhr) denotes a position (arm distal end position) of a distal end portion of the arm.

As illustrated in FIGS. 1 and 2, the arm 102 is obtained by connecting several links and includes joints. In addition, an end effector including fingers is provided at a distal end of the arm, for example.

Note that the appearances illustrated in FIGS. 1 and 2 are examples, and the present invention is not limited thereto. In addition, an attachment position of the arm is not limited to the distal end, and may be the left, right, or the like.

### (Configuration Example of Robot Control System)

FIG. 3 is a diagram illustrating a configuration example of the robot control system according to the embodiment. As illustrated in FIG. 3, the robot control system 1 includes, for example, a robot control device 100 and an operation unit 200.

The robot control device 100 includes the robot body 101, the arm 102, an arm driver 103, an arm sensor 104, a position acquisitor 105, a position command calculator 106, the camera 107, a camera driver 108, a camera sensor 109, an illumination 110, the thruster 111, a thruster driver 112, a control unit 113, a storage 114, a communication unit 116, and a sensor 117.

The operation unit 200 includes, for example, a controller 201, an image display 202, and a communication unit 203.

The operation unit 200 is used by an operator on a ship, for example. Note that the operation unit 200 and the robot control device 100 are connected to each other in a wired manner, for example.

The controller 201 is a device to which the operator inputs an operation command with respect to the robot body 101 and the arm 102. The controller 201 is, for example, a steering wheel, a joystick, a touch panel sensor, or the like.

The image display 202 acquires an image captured by the camera 107, states of the robot body 101 and the arm 102, and the like from the robot control device 100 and displays the acquired result.

The communication unit 203 transmits and receives information to and from the robot control device 100.

The robot body 101 is, for example, a portion other than the arm 102 in FIG. 1. For example, the arm 102, the arm driver 103, the position acquisitor 105, the position command calculator 106, the camera 107, the camera driver 108, the camera sensor 109, the illumination 110, the thruster 111, the thruster driver 112, the control unit 113, the storage 114, the communication unit 116, and the sensor 117 are attached to the robot body 101. Note that, for power supply with respect to the robot body and each functional unit, the robot control device 100 may include a power source, and for example, power may be supplied from a power source on the ship by a cable.

The arm 102 includes the joints as illustrated in FIG. 1, for example. For example, the end effector is attached to a distal end of the arm. For example, an actuator and an encoder (the arm sensor 104) are attached to each of the joints.

The arm driver 103 drives the arm 102 on the basis of a control command. The arm driver 103 includes, for example, an actuator and a drive circuit.

Examples of the arm sensor 104 include the encoder attached to the joint and a six-axis sensor and a tactile sensor attached to a hand.

The position acquisitor 105 acquires each of the arm origin and the position of the arm distal end portion on the basis of a sensor detection value.

The position command calculator 106 defines a constraint model set between the arm origin and the arm distal end portion. The position command calculator 106 calculates a constraining force generated according to a change in a distance between the arm origin and the arm distal end portion from the constraint model, and calculates a position command of the robot body 101 from a value of the constraining force.

The camera 107 is, for example, an image-capturing device using a complementary metal oxide semiconductor (CMOS) imaging element or an image-capturing device using a charge coupled device (CCD) imaging element. Note that the camera 107 may be an RGB (red, green, and blue) D camera that can also obtain depth information D.

The camera driver 108 tilts the camera 107 in a pan-axis direction, for example, on the basis of a camera control instruction included in the control command. The camera driver 108 includes, for example, an actuator and a drive circuit.

The camera sensor 109 detects a tilt of a pan axis of the camera 107.

The illumination 110 is a device capable of changing an on-state and an off-state of an illumination, illuminance of the illumination, a tilt of the illumination, and the like on the basis of an illumination control instruction included in the control command.

The thruster 111 is a device that generates a propulsive force, and is, for example, a propeller, a motor, or the like.

The thruster driver 112 drives the thruster 111 on the basis of a thruster control instruction included in the control command. The thruster driver 112 includes, for example, a drive circuit.

The control unit 113 controls operations of, for example, the robot body 101, the arm 102, the camera 107, the thruster 111, and the like on the basis of the control command.

The storage 114 includes a constraint model 115.

The storage 114 stores a program, a threshold, a predetermined value, a mathematical expression, and the like necessary for control of the robot control device 100. The storage 114 stores, for example, three-dimensional models of the robot body 101 and the arm 102.

The communication unit 116 transmits and receives information to and from the operation unit 200.

The sensor 117 is, for example, a doppler velocity log (DVL) sensor for constant altitude navigation, an internal pressure sensor for constant depth navigation, an inertial measurement unit (IMU), or the like.

### (Coordinate System and Origin)

Next, a coordinate system and an origin in the robot control system 1 will be described.

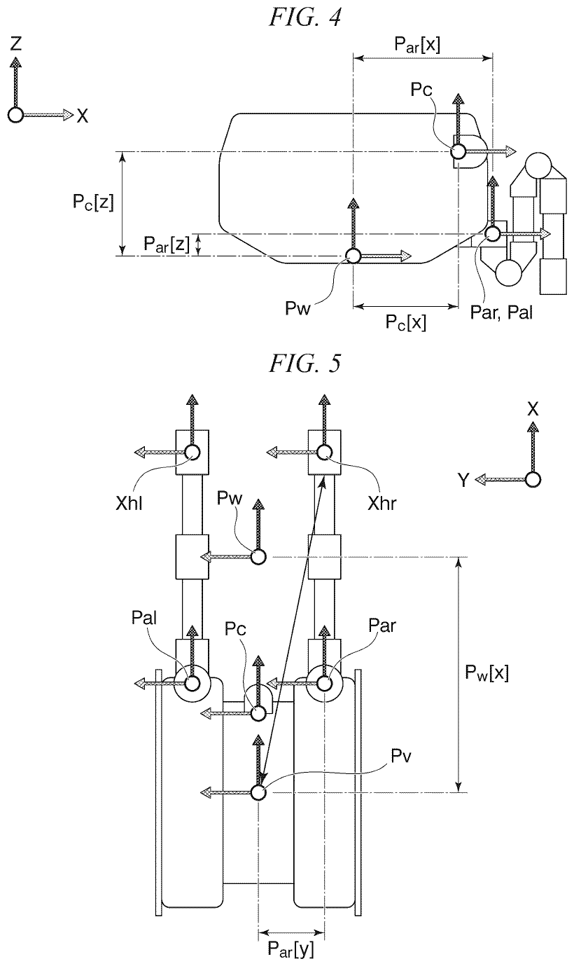

FIGS. 4 and 5 are views illustrating the coordinate system and the origin in the robot control system. FIG. 4 is a view of the robot body as viewed from the side (an xz plane). FIG. 5 is a view viewed from above (an xy plane).

An origin Par of the right arm 102 is (pₐᵣ[x], pₐᵣ[y], pₐᵣ[z]).

An origin Pal of the left arm 102 is (pₐₗ[x], pₐₗ[y], pₐₗ[z]).

A pan-axis origin Pc of the camera 107 is (p_{c}[x], p_{c}[y], p_{c}[z]). A virtual work position Pw is (p_{w}[x], p_{w}[y], p_{w}[z]).

Note that a coordinate origin of the robot body 101 is defined as Pv.

In the present embodiment, a position and posture of the robot body 101 are automatically determined on the basis of a posture of the arm 102 under such constraint conditions.

### (Constraint Condition: First Pattern)

Next, examples of the constraint conditions used in the present embodiment will be described.

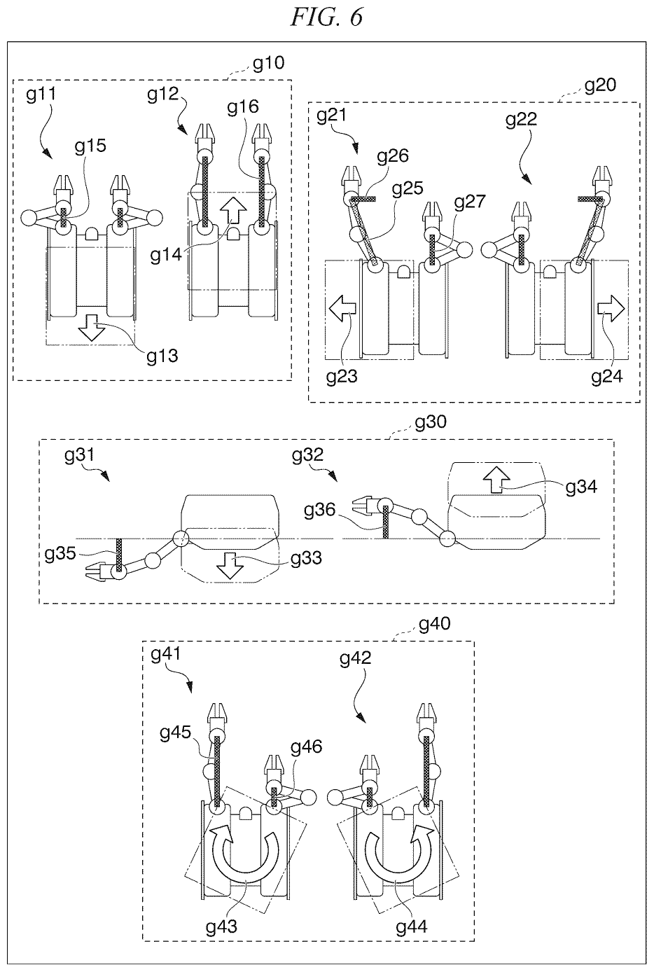

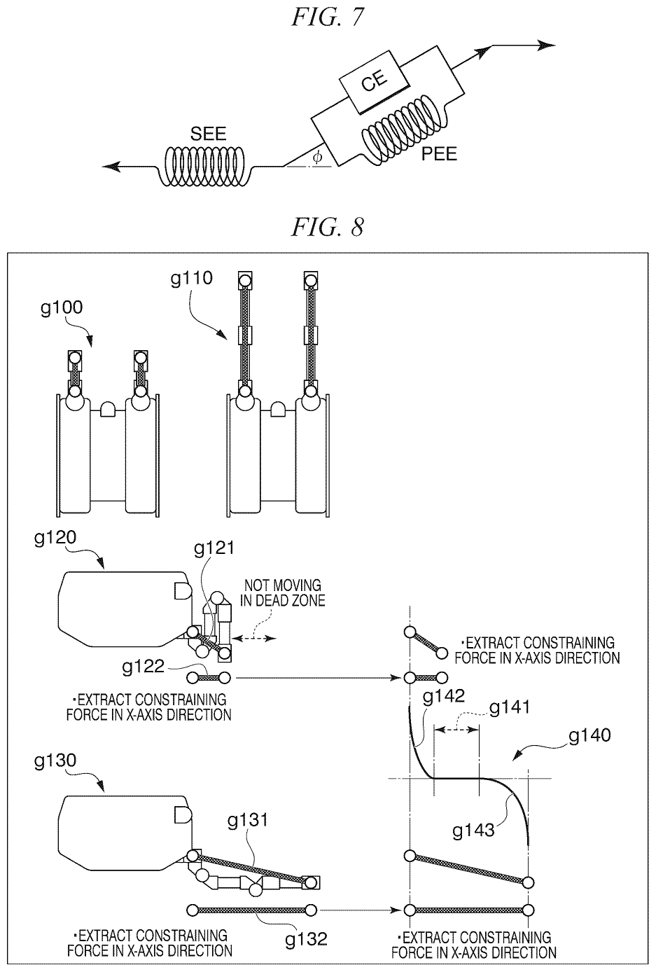

FIG. 6 is a view for describing the examples of the constraint conditions used in the present embodiment. In the present embodiment, a muscle model is defined between the arm 102 and the robot body 101, and the robot body 101 is constrained to an optimum posture. Note that the muscle model is defined by a spring and a damper as illustrated in FIG. 7. FIG. 7 is a view illustrating an example of the muscle model (Hill's muscle mathematical model). Note that the muscle has an actuator function by extension and contraction, and at the same time, has an element that constrains a movement. In FIG. 7, CE is a muscle contracting element, PEE is an elastic element arranged in parallel to CE, and SEE is an elastic element arranged in series to CE. In addition, the contracting element is tilted by a pennation angle φ.

A reference g10 denotes a first constraint condition that determines a command to move the robot body 101 forward or backward (in the x-axis direction) in a case where the arm 102 is extended and contracted forward and backward. A reference g11 denotes a backward movement, and a reference g12 denotes a forward movement. Arrows g13 and g14 denote movement directions. Lines g15 and g16 denote movement components and movement directions of an arm origin and an arm hand position.

A reference g20 denotes a second constraint condition that determines a command to move the robot body 101 to the left or right (in the y-axis direction). A reference g21 denotes a movement to the left, and a reference g22 denotes a movement to the right. Arrows g23 and g24 denote movement directions. Lines g25 to g27 denote movement components and movement directions of the arm origin and the arm hand position.

A reference g30 denotes a third constraint condition that determines a command to move the robot body 101 up or down (in the z-axis direction). A reference g31 denotes a downward movement, and a reference g32 denotes an upward movement. Arrows g33 and g34 denote movement directions. Lines g35 and g36 denote movement components and movement directions of the arm origin and the arm hand position.

A reference g40 denotes a fourth constraint condition, which is a constraint state for determining a rotation (OZ) command of the robot body 101. A reference g41 denotes rotation in a first direction, and a reference g42 denotes rotation in a second direction. Arrows g43 and g44 denote a rotation direction. Lines g45 and g46 denote movement components and movement/rotation directions of the arm origin and the arm hand position. Note that a rotation center is, for example, a gravity center position of the robot body 101, a center position (optical axis) of the camera 107, and an origin of a working coordinate.

(1) First constraint condition (constraint that determines command to move robot body 101 forward or backward (in x-axis direction) in case where arm 102 is extended and contracted forward and backward)

Next, the constraint that determines the forward-backward movement (x-axis direction) command of the robot body 101 will be further described. FIG. 8 is a view for describing the constraint that determines the forward-backward movement (x-axis direction) command of the robot body.

In this case, a constraint model is set between an origin and a hand of the arm 102.

Drawings of references g100 and g120 illustrate a state in which the arms 102 are brought close to the robot body 101 and contracted. Drawings of references g110 and g130 illustrate a state in which the arms 102 are extended away from the robot body 101.

A reference g122 denotes a result of extracting a constraining force in the x-axis direction in a state g121 in which the arm 102 is contracted. A reference 132 denotes a result of extracting a constraining force in the x-axis direction in a state g131 in which the arm 102 is extended.

Using the references g122 and g132 and further a dead zone g141, the constraining force in the x-axis direction, which is the first constraint condition, is represented as a reference g140. Note that it is assumed that the robot body 101 does not move in the dead zone. Note that curved portions g142 and g143 are regions where the constraining force acts. Reasons for the curves are that the muscle model is expressed by the spring and the damper, and thus cannot be operated linearly and that the curves can make natural motion. In addition, the reason why the constraining force is curved is that, since the controller 201 includes a button or a joystick like, for example, a game controller, if the constraining force is made linear, rapid motion is performed even with a slight operation.

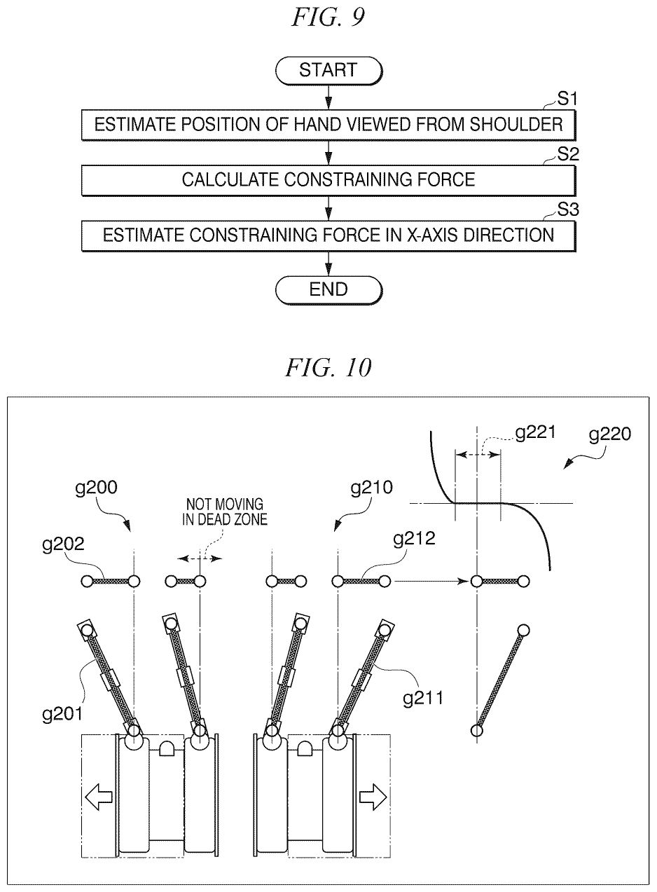

The constraining force is calculated as illustrated in FIG. 9, for example. FIG. 9 is a flowchart of how to obtain the constraining force in the constraint that determines the forward-backward movement command of the robot body.

(Step S1) The position acquisitor 105 estimates a position of the hand viewed from the arm origin (for example, shoulder) by forward kinematics calculation from joint angle information of the arm 102.

(Step S2) The position command calculator 106 calculates a constraining force between the arm origin and the hand from the constraint model 115 stored in the storage 114.

(Step S3) The position command calculator 106 estimates the constraining force in the x-axis direction.

Note that the robot control device 100 performs the above processing for the left and right arms 102.

Note that the position command calculator 106 adds the right and left constraining forces and obtains a change in compliance control (control for adjusting a relationship between a displacement and a generated force; δFconst=Kcomp×δXconst) as a command with respect to the robot body 101.

As a result, for example, control is performed as follows.
I. State in which the right arm 102R is extended and the left arm 102L is in dead zone; the robot body 101 moves forward
II. State in which the right arm 102R is in dead zone and the left arm 102L is extended; the robot body 101 moves forward
III. State in which the left and right arms 102 are extended; the robot body 101 moves forward greatly
IV. State in which the right arm 102R is contracted and the left arm 102L is in dead zone; the robot body 101 moves backward
V. State in which the right arm 102R is in dead zone and the left arm 102L is contracted; the robot body 101 moves backward
VI. State in which the left and right arms 102 are contracted; the robot body 101 moves backward greatly

(2) Second constraint condition (constraint that determines command to move robot body 101 to left or right (in y-axis direction))

Next, the constraint that determines the left-right movement (y-axis direction) command of the robot body 101 will be further described. FIG. 10 is a view for describing the constraint that determines the left-right movement (y-axis direction) command of the robot body.

In this case, a constraint model is set between an origin and a hand position of the arm 102.

A drawing of a reference g200 illustrates a state in which the arms 102 are moved to the left side. A drawing of a reference g21 illustrates a state in which the arms 102 are moved to the right side.

A reference g202 denotes a result of extracting a constraining force in the y-axis direction in a state g201 in which the arm 102 has moved to the left. A reference g212 denotes a result of extracting a constraining force in the y-axis direction in a state g211 in which the arm 102 has moved to the right.

Using the references g202 and g212 and a dead zone g221, the constraining force in the x-axis direction, which is the second constraint condition, is represented as a reference g220. Note that it is assumed that the robot body 101 does not move in the dead zone.

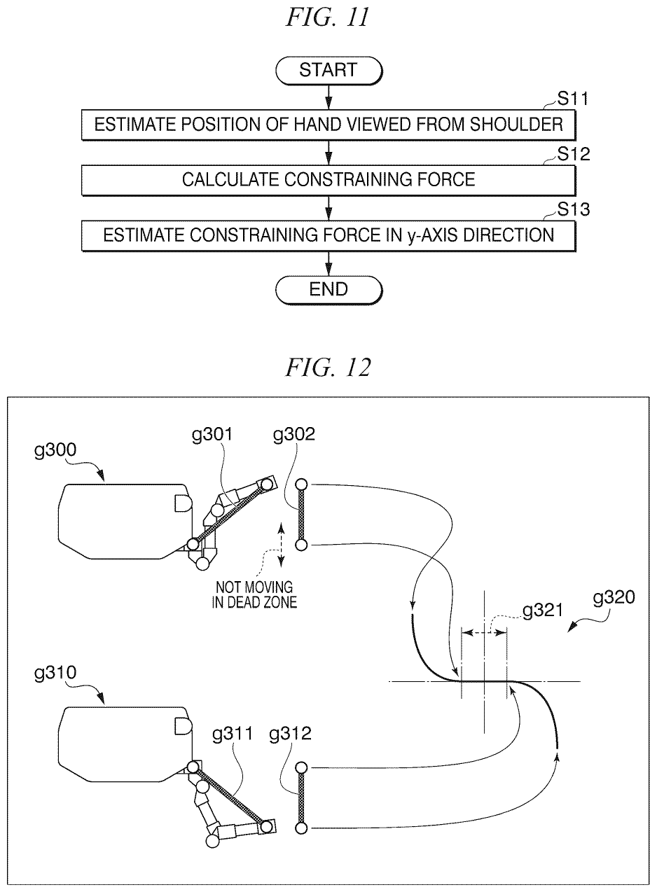

The constraining force is calculated as illustrated in FIG. 11, for example. FIG. 11 is a flowchart of how to obtain the constraining force in the constraint that determines the left-right movement command of the robot body.

(Step S11) The position acquisitor 105 estimates a position of the hand viewed from the arm origin (for example, shoulder) by forward kinematics calculation from joint angle information of the arm 102.

(Step S12) The position command calculator 106 calculates a constraining force between the arm origin and the hand from the constraint model 115 stored in the storage 114.

(Step S13) The position command calculator 106 estimates the constraining force in the y-axis direction.

Note that the robot control device 100 performs the above processing for the left and right arms 102. In addition, the constraint model may be a constraint model between the shoulder and an elbow. Further, an area between left and right shoulders may be defined as a dead zone.

Note that the position command calculator 106 adds the right and left constraining forces and obtains a change in compliance control as a command with respect to the robot body 101.

As a result, for example, control is performed as follows.
I. State in which the right arm 102R is moved to right and the left arm 102L is in dead zone; the robot body 101 moves to right
II. State in which the right arm 102R is in dead zone and the left arm 102L is moved to left; the robot body 101 moves to left
III. State in which the left and right arms 102 are located between shoulders; the robot body 101 stops in y-axis direction
IV. State in which the right arm 102R is moved to right and the left arm 102L is moved to left; either right or left movement of the robot body 101 is determined depending on magnitude of each of right and left constraining force.

(3) Third constraint condition (constraint that determines command to move robot body 101 up and down (in z-axis direction))

Next, the constraint that determines the upward-downward movement (z-axis direction) command of the robot body 101 will be further described. FIG. 12 is a view for describing the constraint that determines the upward-downward movement (z-axis direction) command of the robot body.

In this case, a constraint model is set between an origin and a hand position of the arm 102.

A drawing of a reference g300 illustrates a state in which the arm 102 is moved upward. A drawing of a reference g310 illustrates a state in which the arm 102 is moved downward.

A reference g302 denotes a result of extracting a constraining force in the z-axis direction in a state g301 in which the arm 102 has moved upward. A reference g312 denotes a result of extracting a constraining force in the z-axis direction in a state g311 in which the arm 102 has moved downward.

Using the references g302 and g312 and a dead zone g321, the constraining force in the z-axis direction, which is the third constraint condition, is represented as a reference g320. Note that it is assumed that the robot body 101 does not move in the dead zone.

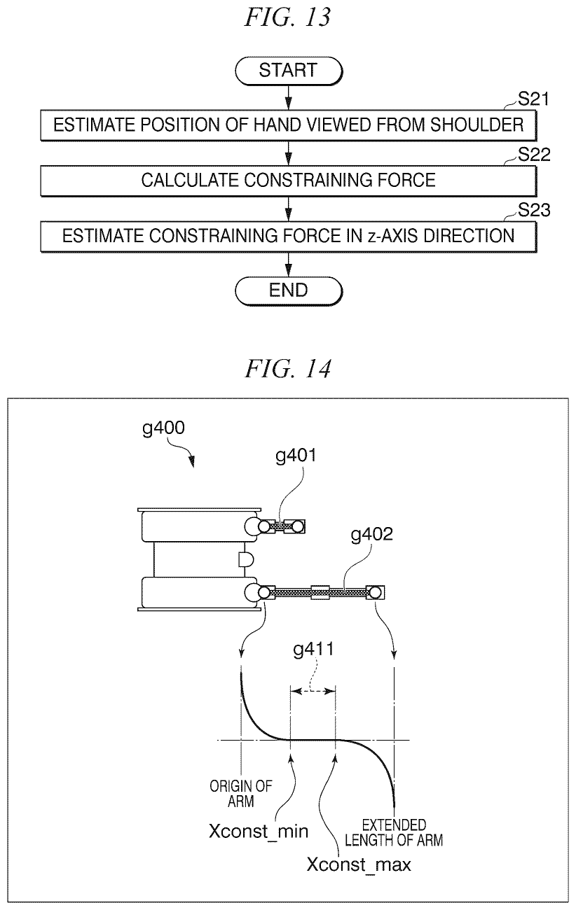

The constraining force is calculated as illustrated in FIG. 13, for example. FIG. 13 is a flowchart of how to obtain the constraining force in the constraint that determines the upward-downward movement command of the robot body.

(Step S21) The position acquisitor 105 estimates a position of the hand viewed from the arm origin (for example, shoulder) by forward kinematics calculation from joint angle information of the arm 102.

(Step S22) The position command calculator 106 calculates a constraining force between the arm origin and the hand from the constraint model 115 stored in the storage 114.

(Step S23) The position command calculator 106 estimates the constraining force in the z-axis direction.

Note that the robot control device 100 performs the above processing for the left and right arms 102. Furthermore, the constraint model may be a constraint model between the arm origin and the elbow.

Note that the position command calculator 106 adds the right and left constraining forces and obtains a change in compliance control as a command with respect to the robot body 101.

As a result, for example, control is performed as follows.
I. State in which the right arm 102R is moved upward and the left arm 102L is in dead zone; the robot body 101 moves in upward direction
II. State in which the right arm 102R is in dead zone and the left arm 102L is moved upward; the robot body 101 moves in upward direction
III. State in which the right and left arms 102 are moved upward; the robot body 101 moves in upward direction greatly IV. State in which the right and left arms 102 are in dead zones; the robot body 101 is stationary
V. State in which the right arm 102R is down and the left arm 102L is in dead zone; the robot body 101 moves in downward direction
VI. State in which the right arm 102R is in dead zone and the left arm 102L is down; the robot body 101 moves in downward direction
VII. State in which the left and right arms 102 are down; the robot body 101 moves in downward direction greatly

(4) Fourth constraint condition (This is constraint state for determining rotation (θZ) command of robot body 101.)

Next, a constraint that determines a rotational movement (z-axis rotation) command of the robot body 101 will be further described. FIG. 14 is a view for describing the constraint that determines the rotational movement (z-axis rotation) command of the robot body.

A drawing of a reference g400 illustrates a state in which the arms 102 are rotationally moved.

A reference g401 represents a state in which the arm 102 is the shortest, and a reference g402 represents a state in which the arm 102 is the longest (fully extended state).

Using the references g401 and g402 and a dead zone g411, the constraining force in the rotation direction, which is the fourth constraint condition, is represented as a reference g410.

Assuming that X is a length of a muscle and X0 is a length of the muscle in a state with the least load on the muscle, (X−X0) obtained by subtracting the length X0 of the muscle in the unloaded state from the entire length of the muscle is a length of the elastic element. This is multiplied by an elastic coefficient Kp to obtain tension generated by the elastic element. The entire tension Fm of the muscle is defined by the elastic element and a viscous element Kd*dX as in the following Formula (1). Note that Ks is a constant.

$$\begin{matrix}[ MATH . 1 ] & \\ Fm = Ks * ( X - XO ) + Kd * KX & ( 1 )\end{matrix}$$

On the premise that the responsiveness of the robot body 101 is low, the dead zone is set before and after the length X0 of the muscle in the most unloaded state. Xconst_max for the extending direction and Xconst_min for the contracting direction are assumed. The constraining force is expressed by the following Formula (2).

$$\begin{matrix}[ MATH . 2 ] & \\ \{ \begin{matrix}if X \geq Xconst\_ max : \\ Fm ( X ) = Ks * ( X - Xconst\_max ) + Kd * dX \\ if Xcont\_max > X > Xcont\_ min : \\ Fm ( X ) = 0 \\ X \leq Xcont\_min : \\ if Fm ( X ) = Ks * ( X - Xcont\_min ) + Kd * dX\end{matrix} & ( 2 )\end{matrix}$$

A constraining force in each axial direction is obtained from postures of the left and right arms 102. For example, the constraining force in each axial direction is used as a virtual force input to obtain a change amount of a position in each axial direction by virtual compliance control. As in the following Formula (3), a change in the amount of rotation is defined as a constraining force moment M viewed from the rotation center, and the virtual compliance control regarding the rotation is similarly defined to obtain a change amount of the rotation.

$$\begin{matrix}[ MATH . 3 ] & \\ δ Xcomp = \frac{Fm ( X )}{Kcomp} & ( 3 )\end{matrix}$$

$$δ Mcomp = \frac{Fm ( M )}{Kcomp}$$

### (Constraint Condition: Second Pattern)

In the first pattern, a potential force is defined between the arm 102 and the robot body 101, and the robot body 101 is constrained to the optimum posture.

Also in a second pattern, four constraint states are similar to those of the first pattern (FIGS. 4 and 6).

In this case, a potential force Fp is defined by, for example, a quadratic function, a sin function, or the like.

A constraining force is expressed by a relationship such as the following Formula (4).

$$\begin{matrix}[ MATH . 4 ] & \\ \{ \begin{matrix}if X \geq Xconst\_max : \\ Fp ( X ) = F ( {X}^{2} ) , F ( sin X ) , … \\ if Xcont\_max > X > Xcont\_ min : \\ Fp ( X ) = 0 \\ if X \leq Xcont\_ min : \\ Fp ( X ) = F ( {X}^{2} ) , F ( sin X ) , …\end{matrix} & ( 4 )\end{matrix}$$

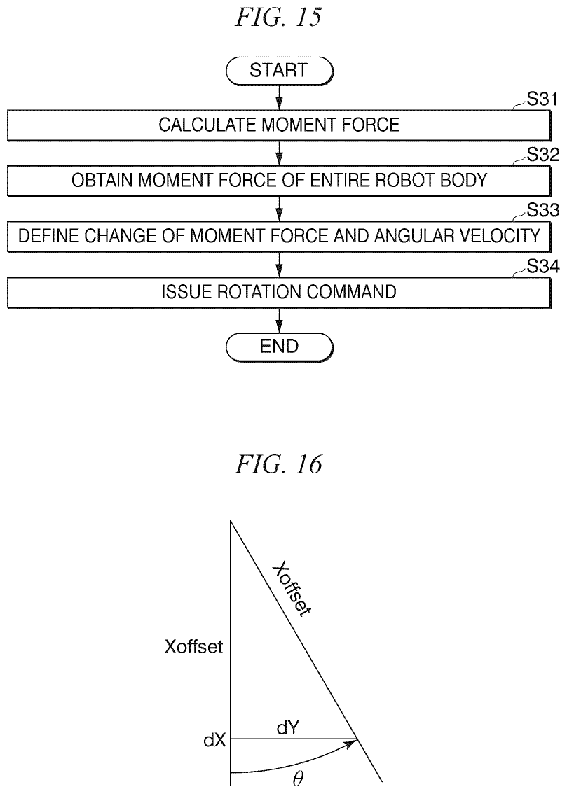

A command with respect to the robot body 101 is issued as illustrated in FIG. 15, for example. FIG. 15 is a flowchart of command processing for the robot body.

(Step S31) The position command calculator 106 calculates a moment force by a product of an offset from an origin of the robot body 101 to a shoulder origin in the lateral direction (y-axis direction) and a constraining force in the x-axis direction with the shoulder as an origin when constraining forces in the x-axis direction of the left and right arms 102 are in a case (a) of having opposite attributes such as extension and contraction, are in a case (b) of extension and a dead zone, and are in a case (c) of contraction and a dead zone.

(Step S32) The position command calculator 106 adds the left and right moment forces to obtain a moment force with respect to the entire robot body 101.

(Step S33) The position command calculator 106 applies a change in a rotation angle about the origin of the robot body 101 to virtual compliance control to define a change in the moment force and an angular change.

(Step S34) The position command calculator 106 issues a rotation command about the z axis to the robot body 101. Note that the position command calculator 106 adds the right and left constraining forces and obtains a change in compliance control as a command with respect to the robot body 101.

As a result, for example, control is performed as follows.
I. State in which the right arm 102R is extended and the left arm 102L is contracted; the robot body 101 rotates counterclockwise
II. State in which the right arm 102R is contracted and the left arm 102L is extended; the robot body 101 rotates clockwise

Note that the following may be treated as an option.
III. State in which the right arm 102R is extended and the left arm 102L is in dead zone; the robot body 101 rotates counterclockwise
IV. State in which the right arm 102R is in dead zone and the left arm 102L is extended; the robot body 101 rotates clockwise

### (First Modification of Fourth Constraint Condition)

Hereinafter, an example in which a setting of the rotation center is selected according to an object will be described.

FIG. 16 is a view for describing a change in each axis and a definition of an offset. When a formed angle is denoted by θ, a change dX in the x-axis direction is expressed by Xoffset (1−cos (θ)). In addition, a change dY in a seven-axis direction is expressed by Xoffset*sin (θ). Note that Xoffset is assumed to be less than (−Dcx, Dwx, Dhx). In addition, Dcx is a distance in the x-axis direction between a pan axis of the camera 107 and an origin of the robot body 101, Dwx is a distance in the x-axis direction between a virtual origin and the origin of the robot body 101, and Dhx is, for example, a distance in the x-axis direction between a left hand and the origin of the robot body 101.

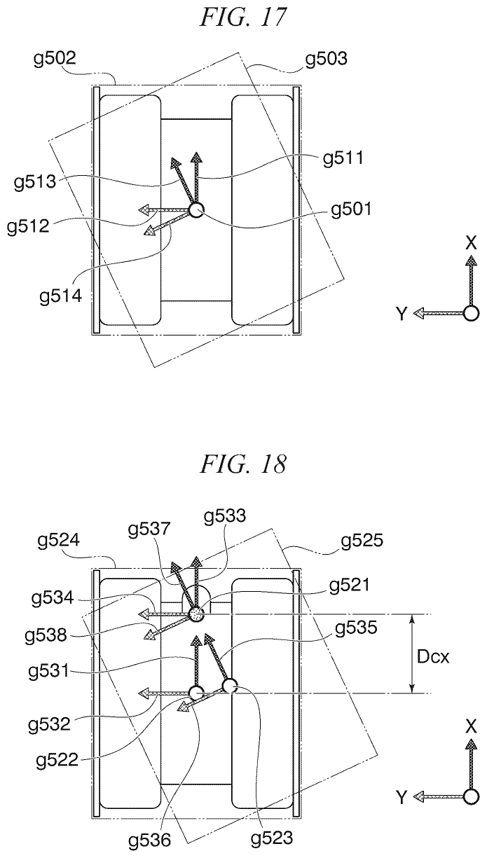

FIG. 17 is a view illustrating an example in a case where the rotation center is an origin of the robot body.

A point g501 is the origin of the robot body. A square g502 is a posture of an appearance of the robot body 101 before rotation. A square g503 is a posture of an appearance of the robot body 101 after rotation.

An arrow g511 is a component in the x-axis direction before rotation at the origin of the robot body 101. An arrow g512 is a component in the y-axis direction before rotation at the origin of the robot body 101. An arrow g513 is a component in the x-axis direction after rotation at the origin of the robot body 101. An arrow g514 is a component in the y-axis direction after rotation at the origin of the robot body 101.

A command in this case changes only in a rotation direction without any change in size of each component.

Therefore, a command Xcmd in the x-axis direction is Xcurrent (the same as a current value), and a command Ycmd in the y-axis direction is Ycurrent (the same as a current value).

FIG. 18 is a view illustrating an example in a case where the rotation center is a pan axis of the camera.

A point g521 is the pan axis of the camera 107. A point g522 is an origin of the robot body before rotation. A point g523 is an origin of the robot body after rotation. A square g524 is a posture of an appearance of the robot body 101 before rotation. A square g525 is a posture of an appearance of the robot body 101 after rotation.

An arrow g531 is a component in the x-axis direction before rotation at the origin of the robot body 101. An arrow g532 is a component in the y-axis direction before rotation at the origin of the robot body 101. An arrow g535 is a component in the x-axis direction after rotation at the origin of the robot body 101. An arrow g536 is a component in the y-axis direction after rotation at the origin of the robot body 101.

An arrow g533 is a component in the x-axis direction before rotation on the pan axis of the camera 107. An arrow g534 is a component in the y-axis direction before rotation at an origin of the pan axis of the camera 107.

An arrow g537 is a component in the x-axis direction after rotation on the pan axis of the camera 107. An arrow g538 is a component in the y-axis direction after rotation on the pan axis of the camera 107.

When it is assumed that a distance in the x-axis direction between the pan axis of the camera 107 and the robot body 101 is Dcx and an angle of a rotation component is θ, the command Xcmd in the x-axis direction is Xcurrent+Dcx*(1−cos (θ)), and the command Ycmd in the y-axis direction is Ycurrent+Dcx*sin (θ).

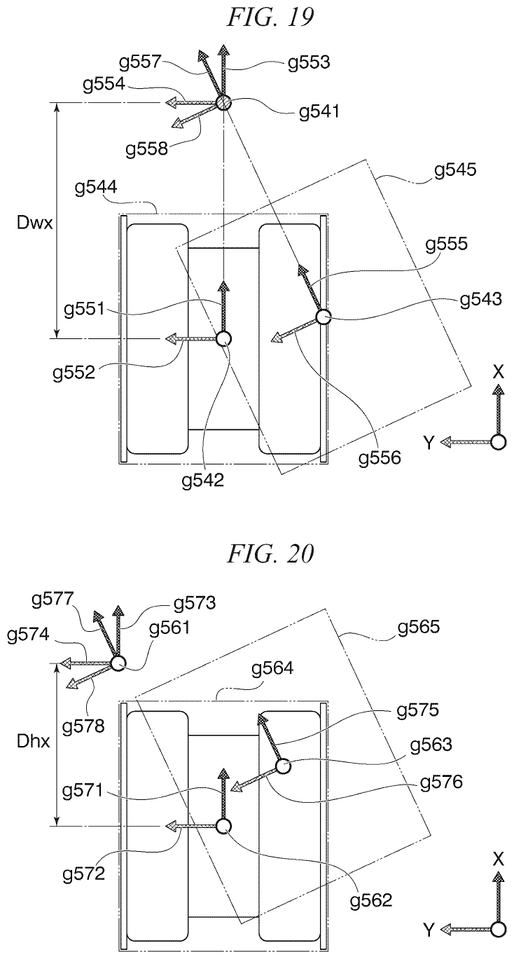

FIG. 19 is a view illustrating an example in which the rotation center is a virtual work position.

A point g541 is the virtual work position. A point g542 is an origin of the robot body before rotation. A point g543 is an origin of the robot body after rotation. A square g544 is a posture of an appearance of the robot body 101 before rotation. A square g545 is a posture of an appearance of the robot body 101 after rotation.

An arrow g551 is a component in the x-axis direction before rotation at the origin of the robot body 101. An arrow g552 is a component in the y-axis direction before rotation at the origin of the robot body 101. An arrow g555 is a component in the x-axis direction after rotation at the origin of the robot body 101. An arrow g556 is a component in the y-axis direction after rotation at the origin of the robot body 101.

An arrow g553 is a component in the x-axis direction before rotation at the virtual work position. An arrow g554 is a component in the y-axis direction before rotation at the virtual work position.

An arrow g557 is a component in the x-axis direction after rotation at the virtual work position. An arrow g558 is a component in the y-axis direction after rotation at the virtual work position.

When it is assumed that a distance between the virtual work position and the robot body 101 in the x-axis direction is Dwx and an angle of a rotation component is θ, the command Xcmd in the x-axis direction is Xcurrent+Dwx*(1−cos (θ)), and the command Ycmd in the y-axis direction is Ycurrent+Dwx*sin (θ).

FIG. 20 is a view illustrating an example in a case where the rotation center is a hand position of the left arm.

A point g561 is the hand position of the left arm 102L. A point g562 is an origin of the robot body before rotation. A point g563 is an origin of the robot body after rotation. A square g564 is a posture of an appearance of the robot body 101 before rotation. A square g565 is a posture of an appearance of the robot body 101 after rotation.

An arrow g571 is a component in the x-axis direction before rotation at the origin of the robot body 101. An arrow g572 is a component in the y-axis direction before rotation at the origin of the robot body 101. An arrow g575 is a component in the x-axis direction after rotation at the origin of the robot body 101. An arrow g576 is a component in the y-axis direction after rotation at the origin of the robot body 101.

An arrow g573 is a component in the x-axis direction before rotation at the hand position of the left arm 102L. An arrow g574 is a component in the y-axis direction before rotation at the hand position of the left arm 102L.

An arrow g577 is a component in the x-axis direction after rotation at the hand position of the left arm 102L. An arrow g578 is a component in the y-axis direction after rotation at the hand position of the left arm 102L.

When it is assumed that a distance between the hand position of the left arm 102L and the robot body 101 in the x-axis direction is Dhx and an angle of a rotation component is θ, the command Xcmd in the x-axis direction is Xcurrent+Dhx*(1−cos (θ)), and the command Ycmd in the y-axis direction is Ycurrent+Dhx*sin (θ).

### (Second Modification of Fourth Constraint Condition)

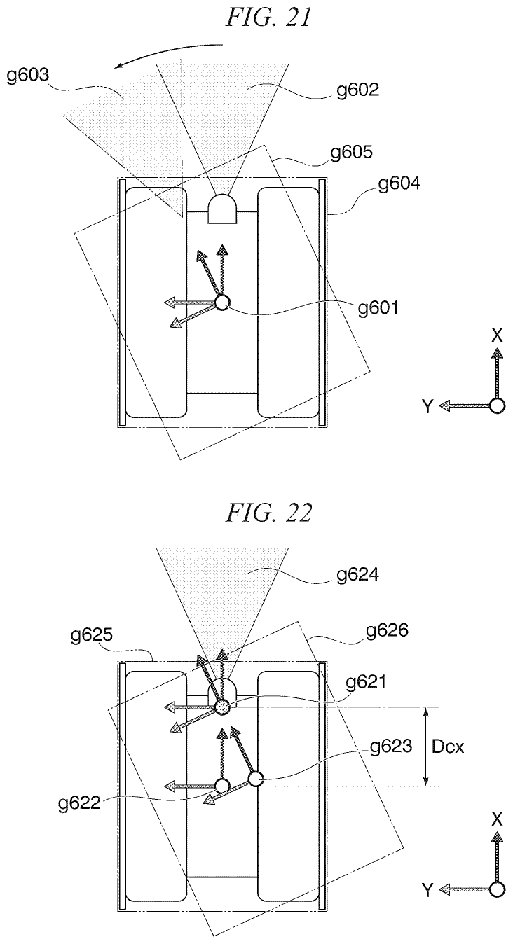

In a case where the camera 107 is attached to the robot body 101, as illustrated in FIG. 21, an image-capturing range is shifted from a reference g602 to a reference g603 when rotation is performed about an origin g601 of the robot body 101 as the rotation center according to movements of the arms. Note that a square g604 is a posture of an appearance of the robot body 101 before rotation. A square g605 is a posture of an appearance of the robot body 101 after rotation. FIG. 21 is a view illustrating an example in which the image-capturing range is shifted when rotation is performed about the origin of the robot body as the rotation center.

For this reason, in the case of control during image capturing, rotation is performed about a pan axis g621 of the camera 107 as illustrated in FIG. 22. FIG. 22 is a view illustrating an example of the image-capturing range in a case where rotation is performed about the pan axis of the camera as the rotation center. A point g622 is an origin position of the robot body 101 before rotation. A point g623 is an origin position of the robot body 101 after rotation. A reference g624 denotes an image-capturing range before and after rotation. A square g625 is a posture of an appearance of the robot body 101 before rotation. A square g626 is a posture of an appearance of the robot body 101 after rotation.

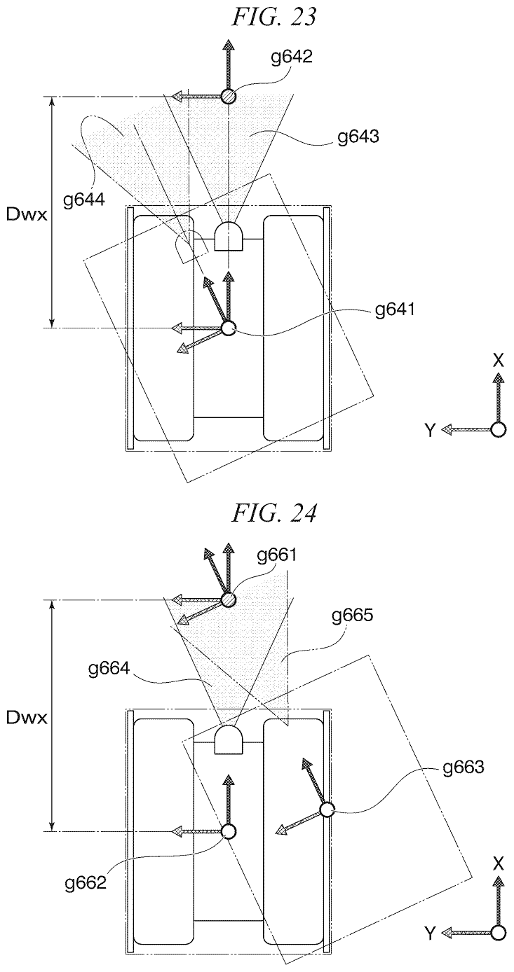

The example in which the image-capturing range is shifted when rotation is performed about the origin of the robot body 101 has been described in the second modification. However, the image-capturing range is also shifted from a reference g643 to a reference g644 as illustrated in FIG. 23 when a virtual work position g642 is set and rotation is performed about an origin g641 of the robot body 101. FIG. 23 is a view illustrating an example in which the image-capturing range is shifted also in a case where the virtual work position is set and rotation is performed about the origin of the robot body.

In such a case, a change in a field of view can be reduced from a reference g664 to a reference g665 by performing rotation about a virtual work position g661 as illustrated in FIG. 24. A point g662 is an origin position of the robot body 101 before rotation. A point g663 is an origin position of the robot body 101 after rotation. FIG. 24 is a view illustrating an example of the field of view in a case where rotation is performed about the virtual work position.

Note that the command Xcmd in the x-axis direction is Xcurrent+Dwx*(1−cos (θ)), and the command Ycmd in the y-axis direction is Ycurrent+Dwx*sin (θ).

Note that the examples described with reference to FIGS. 17 to 24 are examples, and the rotation center may be changed according to the purpose.

Next, an example of a definition of a work position in an absolute coordinate system and a method of controlling a position and a posture of a hand will be described.

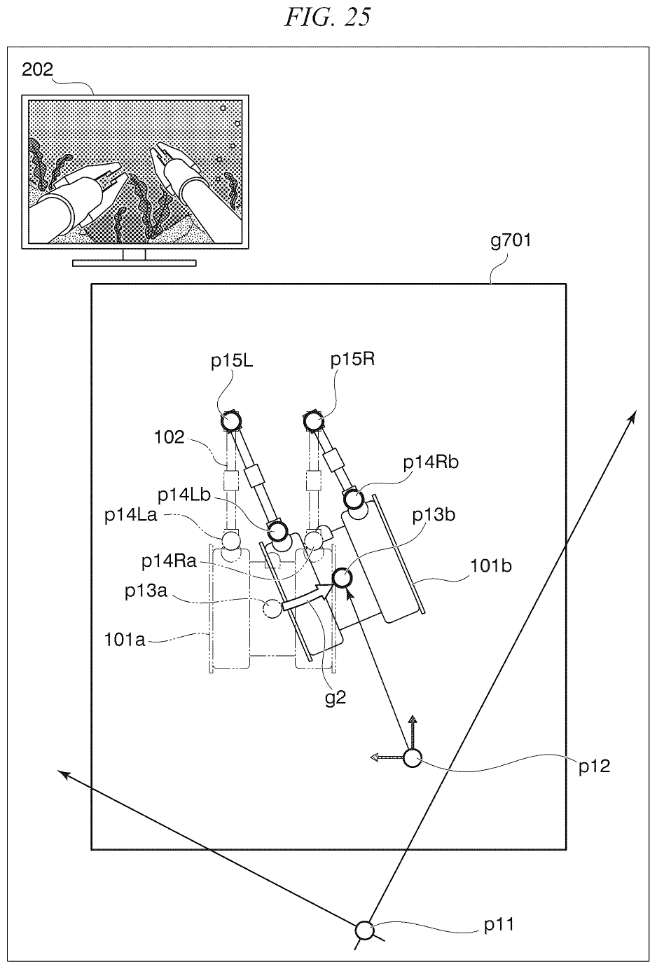

FIG. 25 is a view illustrating the absolute coordinate system, a virtual absolute coordinate system, and a robot coordinate system, and positions and posture positions of the robot body and the hand. A position and posture X of the hand of the arm 102 can be expressed by (x, y, z, θx, θy, θz). In this case, a movable area g701 of the robot is defined based on a virtual origin position as illustrated in FIG. 25.

Note that the virtual absolute coordinate system can be reset at any timing. When the virtual absolute coordinate system is reset at any timing, the virtual absolute coordinate system and the robot coordinate system coincide with each other in the initial state. At that time, the movable area of the robot is three-dimensionally defined based on the virtual origin position. For example, as illustrated in FIG. 25, the movable area g701 may be a rectangular parallelepiped in XYZ directions, a cube, a sphere, or a three-dimensional polygon. The robot body 101 follows a command value from the operator within the movable range. Note that the inside and outside of the movable area g701 may be determined on the basis of a position of the robot body 101. In addition, the inside and outside of the movable range may be determined from a three-dimensional polygon shape of the robot. The position and posture of the hand of the arm 102 of the robot body can be expressed by (x, y, z, θx, θy, θz) in the virtual absolute coordinate system. In addition, a position and posture of the robot body can be expressed by (xr, yr, zr, θrx, θry, θrz) in the virtual absolute coordinate system. Note that the end effector and the camera 107 are omitted in FIG. 25.

In addition, a point p11 is an origin of a global coordinate system when the robot is activated. A point p12 is the virtual origin position of virtual absolute coordinates. A point p13 is an origin of the robot body 101, a point p13a is an origin position of the robot body 101 before movement (rotation), and a point p13b is an origin position of the robot body 101 after movement (rotation). An arrow g2 denotes the movement of the origin of the robot body 101. A point p14 is an arm origin at which the arm 102 is attached to the robot body 101. A point p14La is a left arm origin position before movement (rotation), a point p14Ra is a right arm origin position before movement (rotation), a point p14Lb is a left arm origin position after movement (rotation), and a point p14Rb is a right arm origin position after movement (rotation). A point p15 is a hand position, a point p15L is a left hand position, and a point p15R is a right hand position.

In addition, an image captured by the camera 107 viewed by the operator on the ship through the image display 202 is in a camera coordinate system. Therefore, the operator moves the hands in the camera coordinate system.

Note that the virtual origin position can be reset at any timing. A current position and posture of the robot viewed from the virtual origin position is obtained using the following transformation matrix. In addition, a position of a pan axis of the camera 107, a position of a hand, or the like is obtained as a relative current position and posture viewed from the origin position of the robot using the following transformation matrix.

T_{camera→ROV} is a simultaneous transformation matrix from the camera coordinate system to the robot coordinate system.

T_{ROV→VIRTUAL} is a simultaneous transformation matrix from the robot coordinate system to the virtual coordinate system.

T_{VIRTUAL→GLOBAL} is a simultaneous transformation matrix from the virtual coordinate system to the global coordinate system.

Note that the transformation from the robot coordinate system to the camera coordinate system may include a PAN axis, a TILT axis, and a ROLE axis.

A change in a position and posture of the robot in the virtual coordinate system is expressed by the following Formula (5) using the transformation matrix described above.

$$\begin{matrix}[ MATH . 5 ] & \\ {Xrov}^{VIRTUAL} = \sum {T}_{ROV \to VIRTUAL} \cdot δ {Xrov}^{ROV} & ( 5 )\end{matrix}$$

A change in a command of a position and posture of the robot in the robot coordinate system is expressed by the following Formula (6) using the transformation matrix described above.

$$\begin{matrix}[ MATH . 6 ] & \\ δ {Xrov}^{ROV} = {T}_{CAMERA \to ROV} \cdot δ {Xrov}^{CAMERA} & ( 6 )\end{matrix}$$

The change in the position and posture of the robot in the virtual coordinate system can be expressed by the following Formula (7).

$$\begin{matrix}[ MATH . 7 ] & \\ δ {Xrov}^{VIRTUAL} = \sum δ {Xrov}^{ROV} & ( 7 )\end{matrix}$$

A change in a position and posture of the hand in the virtual coordinate system can be expressed by the following Formula (8).

$$\begin{matrix}[ MATH . 8 ] & \\ δ {Xhand}^{VIRTUAL} [ RL ] = {T}_{ROV \to VIRTUAL} \cdot δ {Xhand}^{ROV} [ RL ] & ( 8 )\end{matrix}$$

A change in a position and posture of the hand in the global coordinate system can be expressed by the following Formula (9).

$$\begin{matrix}[ MATH . 9 ] & \\ δ {Xhand}^{GLOBAL} [ RL ] = {T}_{VIRTUAL \to GLOBAL} \cdot δ {Xhand}^{VIRTUAL} [ RL ] & ( 9 )\end{matrix}$$

A change in a command of a position and posture of the robot in the global coordinate system can be expressed by the following Formula (10).

$$\begin{matrix}[ MATH . 10 ] & \\ δ {Xrov}^{GLOBAL} = {T}_{VIRTUAL \to GLOBAL} \cdot δ {Xrov}^{VIRTUAL} & ( 10 )\end{matrix}$$

A command to cancel a posture change of the robot controlled so as not to move the position and posture of the hand in the global coordinate system is a command of the following Formula (11).

$$\begin{matrix}[ MATH . 11 ] & \\ δ {Xhand}^{ROV} [ RL ] = {T}_{CAMERA \to ROV} \cdot δ {Xhand}^{CAMERA} [ RL ] - δ {Xrov}^{ROV} & ( 11 )\end{matrix}$$

### (Example of Command Generation Block for Robot)

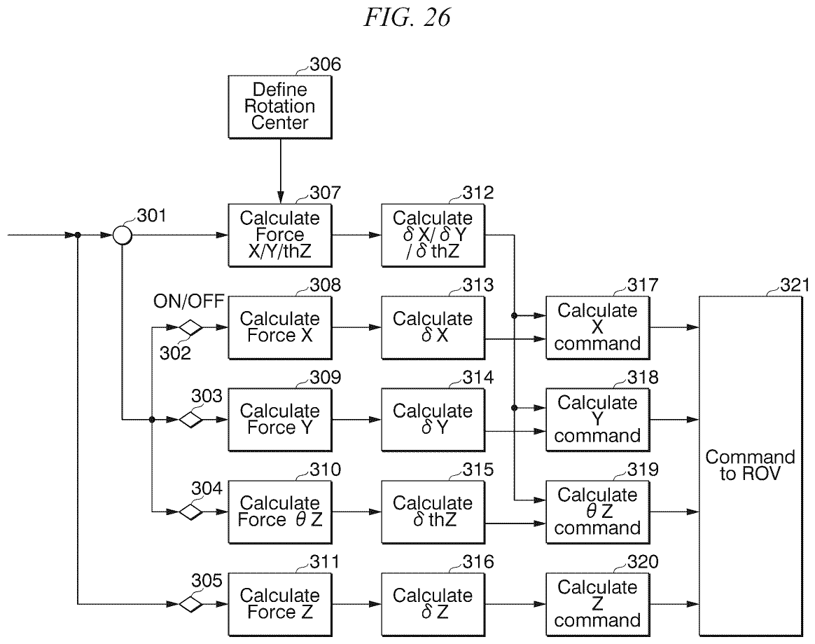

Next, procedure of a process of generating a command with respect to the robot and an example of a command generation block will be described. FIG. 26 is a diagram illustrating the example of the command generation block for the robot according to the embodiment. The command generation block includes, for example, a distributer 301, a determination units 302 to 305, a rotation center definer 306, a constraining force X/Y/thZ calculator 307, a constraining force X calculator 308, a constraining force Y calculator 309, a constraining force θz calculator 310, a constraining force Z calculator 311, a δX/δ/δthZ calculator 312, a δX calculator 313, a δY calculator 314, a δthZ calculator 315, a δZ calculator 316, an X command calculator 317, a Y command calculator 318, a θz command calculator 319, a Z command calculator 320, and a command outputter 321 with respect to the robot.

A sensor detection value, an arm origin in the robot coordinate system, positions of a continuously operating hand in the robot coordinate system, and the like are input to the distributer 301.

Each of the determination units 302 to 305 switches between an on-state and an off-state according to a movement direction of the arm 102, for example, and outputs data input in the on-state to the subsequent stage.

The rotation center definer 306 defines the rotation center, for example, according to the purpose.

The constraining force X/Y/thZ calculator 307 calculates a constraining force in the X/Y/thZ direction according to the movement direction and rotation of the arm 102.

The constraining force X calculator 308 calculates a constraining force in the x-axis direction according to the movement direction of the arm 102.

The constraining force Y calculator 309 calculates a constraining force in the y-axis direction according to the movement direction of the arm 102.

The constraining force θz calculator 310 calculates a constraining force in the θz direction according to the rotation of the arm 102.

The constraining force Z calculator 311 calculates a constraining force in the z-axis direction according to the movement direction of the arm 102.

The δX/δY/δthZ calculator 312 calculates a change amount δX/δY/δthZ using the calculated constraining force in the X/Y/thZ direction.

The δX calculator 313 calculates a change amount δX using the calculated constraining force in the x-axis direction. The δY calculator 314 calculates a change amount δY using the calculated constraining force in the y-axis direction. The δthZ calculator 315 calculates a change amount δthZ using the calculated constraining force in the δthZ direction.

The δZ calculator 316 obtains a change amount δZ using the calculated constraining force in the z-axis direction.

The X command calculator 317 calculates a command in the case of a constraint in the x-axis direction using the above-described transformation matrices and Formulas and the calculated change amount δX/δY/δthZ or change amount δX.

The Y command calculator 318 calculates a command in the case of a constraint in the y axis direction using the above-described transformation matrices and Formulas and the calculated change amount δX/δY/δthZ or change amount δY.

The θz command calculator 319 calculates a command in the case of a constraint in the θz direction using the above-described transformation matrices and Formulas and the calculated change amount δX/δY/δthZ or change amount δthZ.

The Z command calculator 320 calculates a command in the case of a constraint in the z-axis direction using the above-described transformation matrices and Formulas and the calculated change amount δZ.

The command outputter 321 with respect the robot outputs the commands obtained by the X command calculator 317, the Y command calculator 318, the Oz command calculator 319, and the Z command calculator 320 to the robot.

Here, a processing example in a case where the constraint in the X-axis direction is performed will be described.

In this case, a constraint condition is defined between the arm 102 and the robot body 101, and the robot body 101 is constrained to a posture that is optimum for a position and posture of the arm 102.

Procedure 1: The robot control device 100 sets any two points of the robot body 101 and the arm 102, and continuously estimates the distance in the XYZ directions.

Each of the points may be set in any manner as long as a three-dimensional position from a coordinate origin can be estimated and calculated, such as a point on a surface of a link of an arm as well as a rotation center of a joint.

Procedure 2: The distance between any two points changes according to a posture of the arm 102. At that time, the robot control device 100 calculates a change in a potential force as a constraining force by the muscle model, a potential method, or the like.

Note that, in the present embodiment, a dead zone is provided between extension and contraction, and a fine position correction command is not sent to the robot body 101 having poor responsiveness.

As described above, a positive constraining force is generated in a case where the arm 102 is in a fully extended posture, and a negative constraining force is generated in a case where the arm is contracted. As described above, the positive and negative are reversed in the extension and contraction in the present embodiment.

Procedure 3: The robot control device 100 decomposes the change in the constraining force in the XYZ directions in order to constrain a movement of the robot body 101 to cause a movement in any direction. Then, the robot control device 100 defines the change in the constraining force as a virtual constraining force and a displacement generated by the constraining force using virtual compliance control (control for adjusting a relationship between the displacement and the generated force).

Procedure 4: The robot control device 100 commands the robot body 101 to make the displacement generated by the constraining force in any X, Y, or Z direction as a displacement generated in the robot body 101 (base). Note that the constraining force may be a moment force for generating rotation in any direction. In addition, constraining forces in the respective directions of X, Y, Z, thX, thY, and thZ (six degrees of freedom) are independently calculated, and then individually commanded to the robot. In addition, an on-state or an off-state may be set for each of X, Y, Z, thX, thY, and thZ according to a situation. Furthermore, X, Y, Z, thX, thY, and thZ can be individually calculated, but for example, in a case where it is desired to define the rotation center with rotation in thZ, X and Y may be constrained with the rotation in thZ.

As described above, in the present embodiment, the constraint condition is defined between the arm 102 and the robot body 101, and the robot body 101 is constrained to the posture that is optimum for the position and posture of the arm 102. In the present embodiment, the position and posture of the robot body 101 are determined according to the position and posture of the arm 102.

As a result, for example, a working capacity using a manipulator under water can be improved according to the present embodiment.

Note that a program for achieving all or some of the functions of the robot control device 100 in the present invention may be recorded in a computer-readable recording medium, the program recorded in such a recording medium may be read and executed by a computer system, and all or some of the processes may be performed by the robot control device 100. Note that the “computer system” mentioned here includes an OS and hardware such as peripheral devices. In addition, the “computer system” includes a WWW system having a website providing environment (or a display environment). In addition, the “computer-readable recording medium” refers to a portable medium such as a flexible disk, a magneto-optical disk, a ROM, or a CD-ROM, or a storage device such as a hard disk built in a computer system. Furthermore, the “computer-readable recording medium” includes a medium that holds a program for a certain period of time, such as a volatile memory (RAM) inside a computer system that serves as a server or a client when the program is transmitted via a network such as the Internet or a communication line such as a telephone line.

In addition, the program may be transmitted from a computer system in which the program is stored in a storage device or the like to another computer system via a transmission medium or by a transmission wave in the transmission medium. Here, the “transmission medium” for transmitting a program refers to a medium having a function of transmitting information, such as a network (communication network) such as the Internet or a communication line (communication line) such as a telephone line. In addition, the above program may be made for achieving some of the above-described functions. Furthermore, a program capable of achieving the above-described functions in combination with a program already recorded in the computer system, that is, a so-called differential file (differential program) may be applicable.

Heretofore, the modes for carrying out the present invention have been described using the embodiment, but the present invention is not limited to the embodiment described above, and various modifications and substitutions can be made without departing from the gist of the present invention.

### REFERENCE SIGNS LIST

1 Robot control system
100 Robot control device
200 Operation unit
101 Robot body
102, 102L, 102R Arm
103 Arm driver
104 Arm sensor
105 Position acquisitor
106 Position command calculator
107 Camera
108 Camera driver
109 Camera sensor
110 Illumination
111 Thruster
112 Thruster driver
113 Control unit
114 Storage
115 Constraint model
116 Communication unit
117 Sensor
201 Controller
202 Image display
203 Communication unit
301 Distributer
302 to 305 Determination unit
306 Rotation center definer
307 Constraining force X/Y/thZ calculator
308 Constraining force X calculator
309 Constraining force Y calculator
310 Constraining force θz calculator
311 Constraining force Z calculator
312 δX/δY/δthZ calculator
313 δX calculator
314 δY calculator
315 δthZ calculator
316 δZ calculator
317 X command calculator
318 Y command calculator
319 θz command calculator
320 Z command calculator
321 Command outputter with respect to robot

What is claim is:

1.-10. (canceled)

11. A robot control system that controls a robot in a space where the robot is not in contact with a ground, the robot control system comprising:
a robot body;
an arm connected to the robot body;
a position acquisitor that acquires an arm origin set in a vicinity of a point at which the arm is connected to the robot body and a position of an arm distal end portion which is a distal end of the arm; and
a position command calculator that defines a constraint model set between the arm origin and the arm distal end portion, calculates a constraining force generated according to a change in a distance between the arm origin and the arm distal end portion from the constraint model, and calculates a position command of the robot body from a value of the constraining force.

12. The robot control system according to claim 11, wherein
a dead zone is set in the constraint model.

13. The robot control system according to claim 11, wherein
the constraint model is a muscle model or a model based on a potential method.

14. The robot control system according to claim 11, wherein
the constraint model is one of a constraint that determines a front-rear movement command of the robot body, a constraint that determines a left-right movement command of the robot body, a constraint that determines an upward-downward movement command of the robot body, and a constraint that determines a rotation command for rotation of the robot body.

15. The robot control system according to claim 11, further comprising a camera, wherein
the constraint model is a constraint that determines a rotation command for rotation of the robot body, and
a center of the rotation is one of a center of the robot body, a pan axis of the camera, a hand position, and a virtual position.

16. The robot control system according to claim 15, wherein
the center of the rotation is a position at which a change in a field of view of the camera is small when the robot body moves, the position being one of the center of the robot body, the pan axis of the camera, the hand position, and the virtual position.

17. The robot control system according to claim 15, wherein
the position command calculator selects one center of the rotation among the center of the robot body, the pan axis of the camera, the hand position, and the virtual position according to a working state.

18. The robot control system according to claim 11, wherein
the position command calculator estimates a hand position viewed from the arm origin by calculation of forward kinematics from joint angle information of the arm, and calculates a constraining force between the arm origin and the arm distal end portion from the constraint model.

19. The robot control system according to claim 11, wherein
in a case where there are a plurality of the arms, the position command calculator calculates the constraining force for each of the arms, adds the calculated constraining forces of the plurality of arms, and uses a change in compliance control as a command.

20. The robot control system according to claim 12, wherein
in a case where there are a plurality of the arms, the dead zone is located between a vicinity of a point at which a first arm is connected to the robot body and a vicinity of a point at which a second arm is connected to the robot body.
